(19) United States
(12) Patent Application Publication
(10) Pub. No.: US 2022/0229174 A1
(43) Pub. Date: Jul. 21, 2022

(54) DETERMINATION OF VESSEL CARGO CHARACTERISTICS USING INTERFEROMETRY

(71) Applicant: BP CORPORATION NORTH AMERICA INC., Houston, TX (US)

(72) Inventor: Kelly Vaughan, Houston, TX (US)

(73) Assignee: BP CORPORATION NORTH AMERICA INC., Houston, TX (US)

(21) Appl. No.: 17/575,369

(22) Filed: Jan. 13, 2022

Related U.S. Application Data
(60) Provisional application No. 63/137,815, filed on Jan. 15, 2021.

(51) Int. Cl. G01S 13/90

(52) U.S. Cl. CPC G01S 13/9023

(57) ABSTRACT

A method of determining cargo characteristics of a water-borne vessel includes obtaining a first Synthetic Aperture Radar (SAR) image of an area of interest, wherein the water-borne vessel is within the area of interest, and obtaining a second SAR image of the area of interest. In addition, the method includes generating an interferogram using the first SAR image and the second SAR image. Further, the method includes determining a height of the water-borne vessel above a surface of water using the interferogram. Still further, the method includes determining the cargo characteristics of the water-borne vessel based on the height.

### CROSS-REFERENCE TO RELATED APPLICATIONS

This application claims benefit of U.S. provisional patent application Ser. No. 63/137,815 filed Jan. 15, 2021, and entitled “System and Method of Determining Cargo Product Type and Volume Using Interferometry,” which is hereby incorporated herein by reference in its entirety.

### STATEMENT REGARDING FEDERALLY SPONSORED RESEARCH OR DEVELOPMENT

Not applicable.

### BACKGROUND

Water-borne vessels (e.g., cargo ships, container ships, etc.) are used to transmit goods and resources globally. In some circumstances, such as in the case of natural resources like hydrocarbons, an accurate understanding of the type and volume of materials (e.g., oil, gas, coal, etc.) that are held on board such water-borne vessels may be central to making sound management, investment, and trading decisions. However, it is often difficult to ascertain an accurate insight into the nature and characteristics of the cargo that is carried on board a water-borne vessel.

### BRIEF SUMMARY

Some embodiments disclosed herein are directed to a method of determining cargo characteristics of a water-borne vessel. In some embodiments, the method includes obtaining a first Synthetic Aperture Radar (SAR) image of an area of interest, wherein the water-borne vessel is within the area of interest. In addition, the method includes obtaining a second SAR image of the area of interest. Further, the method includes generating an interferogram using the first SAR image and the second SAR image. Still further, the method includes determining a height of the water-borne vessel above a surface of water using the interferogram, and determining the cargo characteristics of the water-borne vessel based on the height.

Some embodiments disclosed herein are directed to a non-transitory machine-readable medium, storing instructions, which, according to some embodiments, when executed by a processor, cause the processor to: generate an interferogram using a first Synthetic Aperture Radar (SAR) image and a second SAR image, wherein the first SAR image and the second SAR image are of an area of interest that includes a water-borne vessel; determine a height of the water-borne vessel above a surface of water using the interferogram; and determining the cargo characteristics of the water-borne vessel based on the height.

Some embodiments disclosed herein are directed to a method of determining cargo characteristics of a water-borne vessel. In some embodiments, the method includes obtaining a first Synthetic Aperture Radar (SAR) image of an area of interest, wherein the water-borne vessel is within the area of interest, and obtaining a second SAR image of the area of interest. In addition, the method includes determining a difference in phase between pixels of the first SAR image and pixels of the second SAR image. Further, the method includes determining a height of the water-borne vessel above a surface of water using the difference in phase between the pixels of the first SAR image and the pixels of the second SAR image. Still further, the method includes determining the cargo characteristics of the water-borne vessel based on the height.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a block diagram of a method of determining the cargo characteristics of a water-borne vessel according to some embodiments;

FIG. 2 is a schematic view of an area of interest including a vessel that is being imaged by one or more aerial imaging devices according to some embodiments;

FIG. 3 is a schematic representation of an interferogram derived from aerial images of the area of interest of FIG. 2 according to some embodiment; and

FIG. 4 is a schematic diagram of a computer system used in one or more of the embodiments disclosed herein.

### DETAILED DESCRIPTION

Determining the nature and characteristics of cargo that is held on board a water-borne vessel may be helpful for a number of purposes. For instance, this information may be useful for understanding various intricacies about an economic market (e.g., such as the hydrocarbon exploration and production market). Specifically, an understanding of the amounts and types of resources and cargo that are being produced, stored, and transported globally may allow one to make more sound trading and purchasing decisions. In addition, an accurate determination of a volume of cargo on board a waterborne vessel may allow for better monitoring and management of natural resources around the globe. For example, one may more accurately monitor a transfer of cargo (e.g., oil, gas, etc.) to or from a water-borne vessel to assess the rates of production and/or transportation of the produced natural resources from a remote location.

Satellites may be used to identify and track various water-borne vessels while they are stationary or en-route between destinations; however, further analysis and information is needed to determine the type, amount, and nature of the cargo that is on board these vessels. In some circumstances, the information relating to the cargo of a particular vessel may be determined via various other data sources (e.g., manifests, databases). However, these sources of information are often inaccurate or may not be available.

Accordingly, embodiments disclosed herein include system and methods for determining the characteristics of a water-borne vessel's cargo. In some embodiments, the systems and methods may use Synthetic Aperture Radar Interferometry (InSAR) (note: “Synthetic Aperture Radar” may be referred to separately herein as “SAR”) to determine one or more cargo characteristics for a water-borne vessel. As used herein, the phrase “cargo characteristics” refers to one or more attributes of the cargo on board a water-borne vessel, including, but not limited to, the weight of the cargo, volume of the cargo, density of cargo, and type(s) of cargo. Thus, through use of the embodiments disclosed herein, one may make useful determinations regarding the cargo being transported in a water-borne vessel via InSAR.

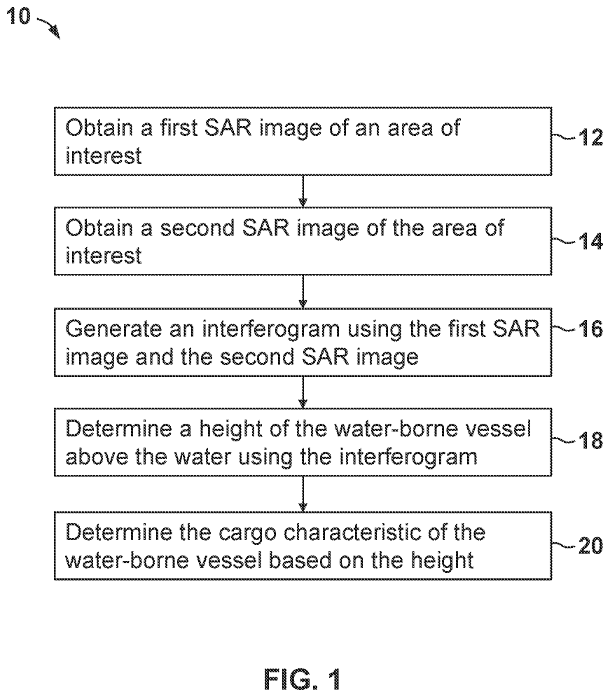

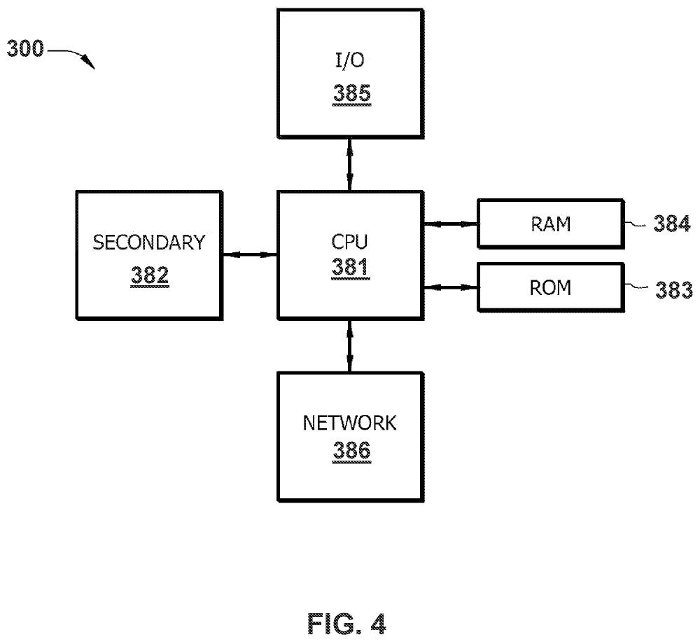

Referring now to FIG. 1, a method 10 of determining the cargo characteristics of a water-borne vessel is shown according to some embodiments. In some embodiments, at least a portion of method 10 may be practiced by a computer system (e.g., computer system 300 shown in FIG. 4). Thus, some features of method 10 may be carried out by a processor that is executing instructions stored on a machine-readable medium.

Initially, method 10 includes obtaining a first SAR image of an area of interest at block 12 and obtaining a second SAR image of the area of interest at block 14. The first and second SAR images in blocks 12 and 14 comprise radar images of the area of interest from a position that is above the area of interest (e.g., from space or from within the Earth's atmosphere but at an elevation above the water-borne vessel).

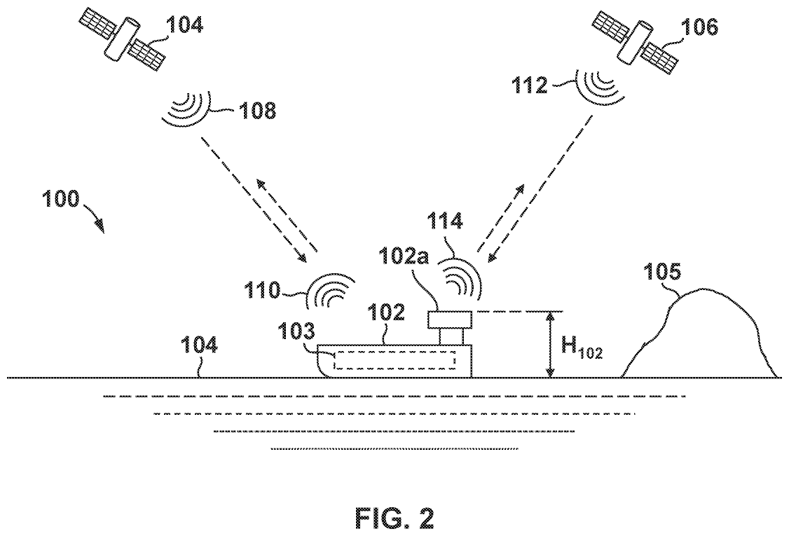

For instance, reference is now made to FIG. 2, which shows a water-borne vessel 102 floating on the surface of the water 104 in a geographical area of interest 100 (or more simply “area of interest 100”). The water-borne vessel 102 (or more simply “vessel 102”) may comprise a ship for transporting cargo 103 over water, such as, for instance a container ship, oil tanker, bulk carrier, etc. The area of interest 100 may comprise any suitable geographic area that includes a navigable body of water, such as for instance a lake, sea, ocean, river, bay, etc. In some embodiments, the area of interest 100 may also include dry land 105.

Referring now to FIGS. 1 and 2, in some embodiments blocks 12 and 14 may comprise obtaining the first and second SAR images of the area of interest 100 using one or more aerial imaging devices 104, 106. The aerial imaging devices 104, 106 may comprise satellites, air planes, drones, helicopters, dirigibles, etc. In some embodiments, the first and second SAR images comprise radar images that are obtained by outputting electromagnetic pulses 108, 112 (e.g., microwaves) from the aerial imaging devices 104, 106, respectively, and directing the electromagnetic pulses 108, 112 toward the area of interest 100. The electromagnetic pulses 108, 112 impact the area of interest 100 and any features positioned therein such as vessel 102, water 104, land 105, etc. The impact of electromagnetic pulses 108, 112 generates reflections 110, 114 (which may be referred to as “backscatter”) that are directed back toward and detected by aerial imaging devices 104, 106, respectively (or more specifically by antenna(s) that are coupled to or incorporated within aerial imaging devices 104, 106).

The first and second SAR images may comprise collections of data of the reflections 110, 114 that are representative of the surface of the Earth within the area of interest 100, and any objects or features contained therein (e.g., vessel 102, land 105, water 104, etc.). The electromagnetic pulses 108, 112 may have known characteristics (e.g., amplitude, phase, wavelength, etc.), and the reflections 110, 114 may comprise one or more characteristics that are altered from the original electromagnetic pulses 110, 114. These alterations in the one or more features of the reflections may be indicative of physical and electrical properties of the area of interest 100 or objects or features contained therein (e.g., vessels 102, water 104, land 105, etc.).

In some embodiments, the first and second SAR images of blocks 12 and 14 are obtained using different aerial imaging devices. For instance, with reference to the area of interest 100 shown in FIG. 2, a first SAR image (e.g., in block 12) is obtained using a first aerial imaging device 104, and a second SAR image (e.g., in block 14) is obtained using a second, different aerial imaging device 106. In some embodiments, the data of the first SAR image and the data of the second SAR image may be captured at the same time or different times by the first aerial imaging device 104 and the second areal imaging device 106, respectively. However, because the first SAR image and the second SAR image are obtained using different aerial imaging devices (e.g., aerial imaging devices 104, 106), the data of the first and second SAR images may be obtained from different locations.

In some embodiments, the first and second SAR images of blocks 12 and 14 may be captured by the same aerial imaging device (e.g., either aerial imaging device 104 or 106), but at different times. In these embodiments, because the aerial imaging devices 104, 106 are moving relative to the surface of the Earth, the first SAR image of block 12 and the second SAR image of block 14 may be captured from different locations even if both SAR images are obtained using the same aerial imaging device (e.g., aerial imaging device 104 or 106).

Once the reflections 110, 114 are captured by the aerial imaging device(s) 104 and/or 106, the data may be subjected to various processing steps in order to convert the received data into the first SAR image and the second SAR image. For instance, images derived directly from the data captured by the aerial imaging devices 104, 106 may have a relatively low azimuth resolution. Accordingly, synthetic aperture processing may be applied to the received data of the reflections 110, 114 to improve the resolution and convert the received data into the first SAR image and the second SAR image as previously described.

Synthetic aperture processing (which may be referred to as “Wiley Aperture Synthesis” or the like) generally refers to a process whereby the resolution (e.g., azimuth resolution) of a radar image is enhanced by deriving a synthetic aperture for the receiving antenna (e.g., the antenna on board the aerial imaging device). Specifically, with respect to the embodiment shown in FIG. 2, the aerial imaging devices 104, 106 are moving while emitting the electromagnetic pulses 108, 112 and while they are receiving the reflections 110, 114. Thus, in processing the data of the reflections 110, 114 into useful images (e.g., the first SAR image and the second SAR image), a synthetic aperture for the aerial imaging device can be theoretically derived over the path of travel for the aerial imaging device while the device was outputting the electromagnetic pulses 108, 112 and receiving the reflections 110, 114. The theoretically derived synthetic aperture may then be used to refine the images that are generated from the collected data (e.g., of the reflections 110, 114).

In some embodiments, processing of the data obtained by the first aerial imaging device 104 and/or the second aerial imaging device 106 may be carried out on board the aerial imaging device(s) 104 and/or 106 (e.g., by one or more computer systems on board aerial imaging devices 104 and/or 106). In some embodiments, processing of the data obtained by the first aerial imaging device 104 and/or the second aerial imaging device 106 may be carried out using one or more computer systems that are separated (and potentially remote) from the aerial imaging devices 104 and/or 106. In some embodiments, processing of the data obtained by the first aerial imaging device 104 and/or the second aerial imaging device 106 may be carried out partially on board the aerial imaging devices 104 and/or 106 and partially by one or more computer systems that are separate from aerial imaging devices 104 and/or 106.

As a result of the processing steps applied to the data collected by the aerial imaging devices 104 and/or 106 (including the synthetic aperture processing described above), the data collected by the aerial imaging devices 104, 106 is converted into the first SAR image and the second SAR image of blocks 12 and 14.

In some embodiments, the first SAR image of block 12 and the second SAR image of block 14 may comprise radar images of a single vessel (e.g., vessel 102) within an area of interest (e.g., area of interest 100). However, in some embodiments, the first SAR image of block 12 and/or the second SAR image of block 14 may comprise radar images of a plurality of vessels (e.g., vessel 102) within an area of interest (e.g., area of interest 100).

In addition, in some embodiments additional sources of information are used to determine the identity of any vessel or vessels 102 that are captured in the first SAR image of block 12 and the second SAR image of block 14. For instance, in some embodiments the Automatic Identification System (AIS) may be utilized or queried to determine the identities of vessels 102 that are present in the area of interest 100 (and thus captured in the first SAR image and/or the second SAR image of blocks 12 and 14, respectively). The AIS may utilize a global positioning system (GPS) along with signals output from each of the vessel(s) 102 to track a position(s) of vessels around the globe. In some embodiments, each of the vessels 102 may be identified with a particular identification number, such as those issued by the International Maritime Organization (IMO), and these numbers may be provided by the AIS to identify vessels 102 in the area of interest 100. In some embodiments, the AIS may be used to identify particular vessels 102 (e.g., by IMO number) that are captured in the first SAR image and the second SAR image obtained at blocks 12 and 14, respectively.

Once the identity of the vessel(s) 102 is determined, further information (e.g., physical characteristics of the vessel and/or the cargo) may be obtained from various databases or other information sources. As will be described in more detail below, these additional pieces of information may be used along with the height of the vessel(s) 102 above the water 104 (e.g., height H₁₀₂) to determine the cargo characteristics of the vessel(s) 102.

Referring again to FIG. 1, at block 16 method 10 includes generating an interferogram using the first SAR image and the second SAR image obtained at blocks 12 and 14, respectively. For instance, the interferogram may comprise an indication of the interference or differences between the first and second SAR images obtained at blocks 12 and 14, respectively. In some embodiments, the interferogram may be generated by first aligning or co-registering the first SAR image with the second SAR image. Specifically, the first SAR image and the second SAR image may both comprise a plurality of pixels arranged in rows and columns. Alignment or co-registration of the first SAR image and the second SAR image may comprise aligning the first and second SAR images so that the pixels of the first and second SAR images that map to the same feature(s) of object(s) (e.g., vessel 102, land 105, water 104) are aligned and corresponded with one another.

After the first and second SAR images are co-registered, the first and second SAR images may be cross-multiplied to derive the interferogram. During this process, the amplitude values of the first and second SAR images are multiplied while their respective phases are differenced on a pixel-by-pixel basis. More specifically, the amplitude value of each pixel of the first SAR image is multiplied by the amplitude value of the corresponding pixel of the second SAR image. In addition, the phase value of each pixel of the second SAR image are subtracted from the phase value of the corresponding pixel of the first SAR image. The result of these computations is an image of the area of interest 100 having pixels comprising the combined amplitude and phase values described above. This resulting, combined image is the interferogram of block 16. Thus, the interferogram of block 16 may comprise a combination of the first and second SAR images of the geographical area of interest (area of interest 100 shown in FIG. 2) that depicts changes in phase across the area of interest 100 on a pixel-by-pixel basis. The combined phase values in the interferogram of block 16 may be referred to as “interferometric phase values.” Thus, each pixel of the interferogram of block 16 may comprise an interferometric phase value that is the difference between phase values of co-registered (aligned) pixels of the first and second SAR images of blocks 12 and 13, respectively.

The generation of the interferogram of block 16 comprises InSAR for the SAR images obtained in blocks 12 and 13. Thus, block 16 may be referred to as performing InSAR on the first and second SAR images of blocks 12 and 13, respectively.

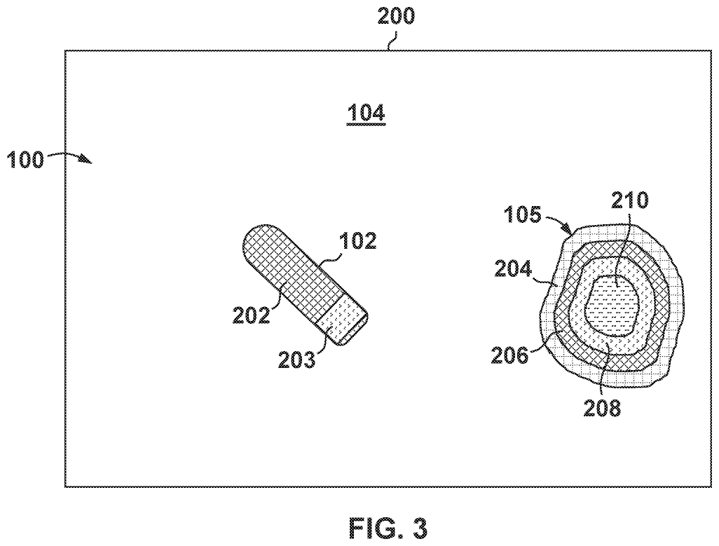

In some embodiments, the interferogram of block 16 may comprise a heat map of the area of interest wherein differences in color, patterning, infill, etc. may indicate varying values of a change in phase across the area of interest as determined by the aerial images obtained at block 12. For instance, reference is now made to FIG. 3, which shows a schematic representation of an example interferogram 200 of the area of interest 100 from FIG. 2 according to some embodiments (for simplicity, the schematic representation of the example interferogram 200 in FIG. 3 may simply be referred to as “interferogram 200” herein). The interferogram 200 of FIG. 3 may be derived from first and second SAR images of the area of interest 100 are described above. The interferogram 200 includes a plurality of gradations 202, 203, 204, 206, 208, 210 that represent differences in phase between the two SAR images of area of interest 100.

Referring again to FIG. 1, method 10 also includes determining a height of the water-borne vessel above the water using the interferogram at block 18. Referring briefly again to FIG. 2, the height H₁₀₂ of vessel 102 may comprise a vertical height of a top of vessel 102 or the height of some fixed surface, object, or other reference point (e.g., a deck) on vessel 102 above the surface of the water 104. In some embodiments (e.g., such as is shown in FIG. 2) the height H₁₀₂ comprises a vertical height of the uppermost or top surface 102a of the vessel 102 above the surface of the water 104.

Referring now to FIGS. 1-3, as previously described, the interferogram 200 may comprise a heat map showing gradations 202, 203, 204, 206, 208, 210 in interferometric phase values (e.g., relative to the first and second SAR images) across the area of interest 100. The differences of the interferometric phase values indicated by the gradations 202, 203, 204, 206, 208, 210 in the interferogram 200 may provide an indication of the vertical distance between the aerial imaging device(s) 104 and/or 106 and the object/features in the image. The differences in vertical distance between the aerial imaging devices(s) 104 and/or 106 and the objects/features in the interferogram 200 may, in turn provide a measure of the different relative vertical distances or heights of the objects/features.

In some embodiments, the interferometric phase values (or a difference therebetween) of the pixels in the interferogram 200 may be subjected to processing that relates the change in interferometric phase values to differences in vertical height. For instance, in some embodiments the processing may include flattening of the interferogram (e.g., by subtraction of unwanted or irrelevant interferometric phase contribution, such as by use of some reference data or information), phase unwrapping, and conversion of the interferometric phase values to height values based on the wavelength of the output radar waves 108, 112.

In some embodiments, determination of the vertical height H₁₀₂ may also include utilizing information from additional sources. For instance, in some embodiments, the further processing of the interferogram 200 may also include other known or determinable factors such as, for instance, the known characteristics of the output radar waves 108, 112 (e.g., phase, amplitude, etc.) as well as the position and height (e.g., altitude) of the aerial image device(s) (e.g., devices 104, 106) when the aerial images were obtained. In some embodiments, the height of the water-borne vessel above the water (e.g., height H₁₀₂ of vessel 102) may be determined by determining the vertical distance between the aerial imaging device (e.g., aerial imaging devices 104, 106) and the object (e.g., vessel 102) depicted in the pixels of interest within the interferogram 200.

Referring again to FIG. 1, after the height of the water-borne vessel is determined at block 18, method 10 may proceed to block 20 to determine the cargo characteristics of the water-borne vessel's 102 cargo using the height. Specifically, referring again to FIG. 2, once the height H₁₀₂ of the vessel 102 is determined, additional analysis may be performed to determine the cargo characteristics of vessel 102 based, at least in part, on the height H₁₀₂ along with other information.

In some embodiments, the cargo characteristics at block 20 may comprise a volume of cargo 103 on vessel 102. For example, a water-borne vessel's height (e.g., height H₁₀₂) is a mathematical function of its total mass, the density of the cargo, and the water conditions (e.g., water temperature, salinity, etc.). The total mass of the vessel 102 is in-turn a function of the physical characteristics of the vessel 102 itself (e.g., mass, dimensions, etc.), mass of the cargo 103, and any other sources of mass on vessel 102. In some embodiments, assumptions can be made for the density of cargo 103. For instance, it may be assumed (e.g., based on the type of vessel 102, ownership of the vessel 102, departure port of vessel 102, manifest, etc.) that the cargo 103 is of a particular type (e.g., oil, gas, minerals, etc.). As a result, based on this information, an assumption may be made as to the density of the cargo 103. Together, the assumed density of the cargo 103 along with the vessel height H₁₀₂ (e.g., which is determined via blocks 18 as previously described) and the other known, determined, or assumed characteristics of the vessel 102 are used to mathematically determine or estimate the volume of the cargo 103.

In some embodiments, the cargo characteristics in block 20 may comprise a density or type of cargo 103 on vessel 102. In these embodiments a similar technique may be used to determine the density and type of cargo 103 on vessel 102 using the height H₁₀₂ (determined via block 18 as previously described) and other known, determined, or assumed information regarding the volume of cargo 103 as described above. For instance, if a vessel type has a cargo hold of known size, and it is known or assumed that the vessel's 102 cargo hold has been filled to capacity (or to a particular percentage or fraction of full capacity), then the volume of the cargo 103 may be assumed with a reasonable degree of accuracy, and this assumed cargo volume can then be used along with the other information described above in order to determine the density (and therefore the type) of the cargo 103 being transported on vessel 102.

In some embodiments, the cargo characteristics may be determined at block 20 using equations (1) and (2) below:

$$\begin{matrix}( {m}_{cargo} + {m}_{vessel} + {m}_{other} ) = {ρ}_{water} \cdot {V}_{disp} ; & ( 1 ) \\ {V}_{cargo} = {m}_{cargo} / {ρ}_{cargo} . & ( 2 )\end{matrix}$$

In equations (1) and (2) above, m_{cargo} represents the mass of cargo 103, mᵥₑₛₛₑₗ represents the mass of the vessel 102, and mother represents the mass of other equipment, personnel, objects, etc. that are on board vessel 102, other than cargo 103. In addition, in equations (1) and (2) above, ρ_{water} and ρ_{cargo} refer to the densities of the water 104 and cargo 103, respectively. Further, in equations (1) and (2) above, V_{disp} refers to the total volume of water 104 that is displaced by vessel 102 and V_{cargo} refers to the volume of the cargo 103. At least some of the features of equations (1) and (2) may be defined in terms of the height H₁₀₂ of vessel 102 above water 104 (e.g., V_{disp}), such that once the height H₁₀₂ is determined using the interferogram per block 18 as describe above, equations (1) and (2) may be used to determine various cargo characteristics such as m_{cargo}, V_{cargo}, ρ_{cargo} or values/information based thereon (e.g., type of cargo 103).

Accordingly, embodiments disclosed herein include system and methods for determining the cargo characteristics of a water-borne vessel. In some embodiments, the systems and methods may use InSAR to determine a height (e.g., H₁₀₂) of the vessel above the surface of the water, which may then be used to determine the cargo characteristics of the water-borne vessel. Thus, through use of the embodiments disclosed herein, one may make useful determinations regarding the cargo being transported in a water-borne vessel via aerial imaging, which may then better inform management and/or financial (e.g., trading) decisions.

Any of the systems and methods disclosed herein can be carried out (e.g., entirely or partially) on a computer or other device comprising a processor (e.g., a desktop computer, a laptop computer, a tablet, a server, a smartphone, or some combination thereof). FIG. 4 illustrates a computer system 300 suitable for implementing one or more embodiments disclosed herein. The computer system 300 includes a processor 381 (which may be referred to as a central processor unit or CPU) that is in communication with memory devices including secondary storage 382, read only memory (ROM) 383, random access memory (RAM) 384, input/output (I/O) devices 385, and network connectivity devices 386. The processor 381 may be implemented as one or more CPU chips.

It is understood that by programming and/or loading executable instructions onto the computer system 300, at least one of the CPU 381, the RAM 384, and the ROM 383 are changed, transforming the computer system 300 in part into a particular machine or apparatus having the novel functionality taught by the present disclosure. Thus, the RAM 384 and/or the ROM 383 may comprise a non-transitory machine-readable (or computer-readable) medium that may include instructions that are executable by CPU 381 to provide functionality to computer system 300.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 300 is turned on or booted, the CPU 381 may execute a computer program or application. For example, the CPU 381 may execute software or firmware stored in the ROM 383 or stored in the RAM 384. In some cases, on boot and/or when the application is initiated, the CPU 381 may copy the application or portions of the application from the secondary storage 382 to the RAM 384 or to memory space within the CPU 381 itself, and the CPU 381 may then execute instructions of which the application is comprised. In some cases, the CPU 381 may copy the application or portions of the application from memory accessed via the network connectivity devices 386 or via the I/O devices 385 to the RAM 384 or to memory space within the CPU 381, and the CPU 381 may then execute instructions of which the application is comprised. During execution, an application may load instructions into the CPU 381, for example load some of the instructions of the application into a cache of the CPU 381. In some contexts, an application that is executed may be said to configure the CPU 381 to do something, e.g., to configure the CPU 381 to perform the function or functions promoted by the subject application. When the CPU 381 is configured in this way by the application, the CPU 381 becomes a specific purpose computer or a specific purpose machine.

The secondary storage 382 is typically comprised of one or more disk drives or tape drives and is used for non-volatile storage of data and as an over-flow data storage device if RAM 384 is not large enough to hold all working data. Secondary storage 382 may be used to store programs which are loaded into RAM 384 when such programs are selected for execution. The ROM 383 is used to store instructions and perhaps data which are read during program execution. ROM 383 is a non-volatile memory device which typically has a small memory capacity relative to the larger memory capacity of secondary storage 382. The RAM 384 is used to store volatile data and perhaps to store instructions. Access to both ROM 383 and RAM 384 is typically faster than to secondary storage 382. The secondary storage 382, the RAM 384, and/or the ROM 383 may be referred to in some contexts as computer readable storage media and/or non-transitory computer readable media.

I/O devices 385 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 386 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 386 may enable the processor 381 to communicate with the Internet or one or more intranets. With such a network connection, it is contemplated that the processor 381 might receive information from the network, or might output information to the network (e.g., to an event database) in the course of performing the methods described herein. Such information, which is often represented as a sequence of instructions to be executed using processor 381, may be received from and outputted to the network, for example, in the form of a computer data signal embodied in a carrier wave.

Such information, which may include data or instructions to be executed using processor 381 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 381 executes instructions, codes, computer programs, scripts which it accesses from hard disk, floppy disk, optical disk (these various disk based systems may all be considered secondary storage 382), flash drive, ROM 383, RAM 384, or the network connectivity devices 386. While only one processor 381 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 382, for example, hard drives, floppy disks, optical disks, and/or other device, the ROM 383, and/or the RAM 384 may be referred to in some contexts as non-transitory instructions and/or non-transitory information.

In an embodiment, the computer system 300 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 300 to provide the functionality of a number of servers that is not directly bound to the number of computers in the computer system 300. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 300, at least portions of the contents of the computer program product to the secondary storage 382, to the ROM 383, to the RAM 384, and/or to other non-volatile memory and volatile memory of the computer system 300. The processor 381 may process the executable instructions and/or data structures in part by directly accessing the computer program product, for example by reading from a CD-ROM disk inserted into a disk drive peripheral of the computer system 300. Alternatively, the processor 381 may process the executable instructions and/or data structures by remotely accessing the computer program product, for example by downloading the executable instructions and/or data structures from a remote server through the network connectivity devices 386. The computer program product may comprise instructions that promote the loading and/or copying of data, data structures, files, and/or executable instructions to the secondary storage 382, to the ROM 383, to the RAM 384, and/or to other non-volatile memory and volatile memory of the computer system 300.

In some contexts, the secondary storage 382, the ROM 383, and the RAM 384 may be referred to as a non-transitory computer readable medium or a computer readable storage media. A dynamic RAM embodiment of the RAM 384, likewise, may be referred to as a non-transitory computer readable medium in that while the dynamic RAM receives electrical power and is operated in accordance with its design, for example during a period of time during which the computer system 300 is turned on and operational, the dynamic RAM stores information that is written to it. Similarly, the processor 381 may comprise an internal RAM, an internal ROM, a cache memory, and/or other internal non-transitory storage blocks, sections, or components that may be referred to in some contexts as non-transitory computer readable media or computer readable storage media.

The discussion above is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion above and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, when used herein (including in the claims), the words “about,” “generally,” “substantially,” “approximately,” and the like mean within a range of plus or minus 10%.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method of determining cargo characteristics of a water-borne vessel, the method comprising:
obtaining a first Synthetic Aperture Radar (SAR) image of an area of interest, wherein the water-borne vessel is within the area of interest;
obtaining a second SAR image of the area of interest;
generating an interferogram using the first SAR image and the second SAR image;
determining a height of the water-borne vessel above a surface of water using the interferogram; and
determining the cargo characteristics of the water-borne vessel based on the height.

2. The method of claim 1, wherein the cargo characteristics comprise at least one of:
a volume of cargo on board the water-borne vessel;
a density of cargo on board the water-borne vessel; or
a type of cargo on board the water-borne vessel.

3. The method of claim 2, wherein generating the interferogram comprises:
combining the first SAR image with the second SAR image; and
computing a phase difference between pixels of the first SAR image and corresponding pixels of the second SAR image.

4. The method of claim 3, wherein determining the height of the water-borne vessel comprises determining the height of the water-borne vessel based on the phase difference.

5. The method of claim 4, wherein obtaining the first SAR image comprises obtaining the first SAR image with a first aerial imaging device at a first location, and wherein obtaining the second SAR image comprises obtaining the second SAR image with a second aerial imaging device at a second location.

6. The method of claim 5, wherein the first aerial imaging device and the second aerial imaging device comprise satellites.

7. The method of claim 6, wherein the first SAR image and the second SAR image are obtained substantially simultaneously.

8. The method of claim 4, wherein obtaining the first SAR image comprises obtaining the first SAR image using an aerial imaging device at a first location, and wherein obtaining the second SAR image comprises obtaining the second SAR image using the aerial imaging device at a second location.

9. A non-transitory machine-readable medium, storing instructions, which, when executed by a processor, cause the processor to:
generate an interferogram using a first Synthetic Aperture Radar (SAR) image and a second SAR image, wherein the first SAR image and the second SAR image are of an area of interest that includes a water-borne vessel;
determine a height of the water-borne vessel above a surface of water using the interferogram; and
determining the cargo characteristics of the water-borne vessel based on the height.

10. The non-transitory machine-readable medium of claim 10, wherein the cargo characteristics comprise at least one of:
a volume of cargo on board the water-borne vessel;
a density of cargo on board the water-borne vessel; or
a type of cargo on board the water-borne vessel.

11. The non-transitory machine-readable medium of claim 11, wherein the instructions, when executed by the processor, cause the processor to generate the interferogram by:
combining the first SAR image with the second SAR image; and
computing a phase difference between pixels of the first SAR image and corresponding pixels of the second SAR image.

12. The non-transitory machine-readable medium of claim 12, wherein the instructions, when executed by the processor, cause the processor to determine the height of the water-borne vessel based on the phase difference.

13. The non-transitory machine-readable medium of claim 13, wherein the instructions, when executed by the processor, cause the processor to provide the phase difference as an input to a mathematical model and receive an indication of the height of the water-borne vessel from the mathematical model.

14. A method of determining cargo characteristics of a water-borne vessel, the method comprising:
obtaining a first Synthetic Aperture Radar (SAR) image of an area of interest, wherein the water-borne vessel is within the area of interest;
obtaining a second SAR image of the area of interest;
determining a difference in phase between pixels of the first SAR image and pixels of the second SAR image;
determining a height of the water-borne vessel above a surface of water using the difference in phase between the pixels of the first SAR image and the pixels of the second SAR image; and
determining the cargo characteristics of the water-borne vessel based on the height.

15. The method of claim 14, wherein the cargo characteristics comprise at least one of:
a volume of cargo on board the water-borne vessel;
a density of cargo on board the water-borne vessel; or
a type of cargo on board the water-borne vessel.

16. The method of claim 14, wherein obtaining the first SAR image comprises obtaining the first SAR image with a first aerial imaging device at a first location, and wherein obtaining the second SAR image comprises obtaining the second SAR image with a second aerial imaging device at a second location.

17. The method of claim 16, wherein the first aerial imaging device and the second aerial imaging device comprise satellites.

18. The method of claim 14, wherein the first SAR image and the second SAR image are obtained substantially simultaneously.

19. The method of claim 14, wherein obtaining the first SAR image comprises obtaining the first SAR image using an aerial imaging device at a first location, and wherein obtaining the second SAR image comprises obtaining the second SAR image using the aerial imaging device at a second location.
